(19) United States
(12) Patent Application Publication
(10) Pub. No.: US 2010/0061178 A1
(43) Pub. Date: Mar. 11, 2010

(54) Mixer Control Device And System

(76) Inventors: Yoshiaki Miyazato, Chiba (JP); Yuji Makita, Tokyo (JP)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/573,601

(22) PCT Filed: Aug. 8, 2005
(86) PCT No.: PCT/JP05/14540

§ 371 Date: Aug. 17, 2007

(30) Foreign Application Priority Data
Aug. 13, 2004 (JP) 2004-236110

(51) Int. Cl. A21C 1/00

(52) U.S. Cl. 366/100

(57) ABSTRACT

A mixer control device capable of manufacturing products of consistent quality without skilled personnel is provided. Said mixer control device includes: (1) a sensor 3 for obtaining manufacturing-conditions data, including at least the temperatures of the raw materials, the temperature of the room in which the manufacturing occurs, and the temperature of the product being manufactured, along with changes in such manufacturing-conditions data; (2) a manufacturing-conditions-data acquisition means 13 for obtaining and maintaining the manufacturing-conditions data from said sensor; (3) correction data 12 for correcting the feed-water temperature based on said obtained manufacturing-conditions data; (4) a feed-conditions setting means 15 for setting the feed conditions, including at least the mixing time of the mixer and a product's feed-water temperature, according to the feed amounts of the raw materials based on said correction data; and (5) a mixer control means 16 for controlling said mixer, based on said feed conditions.

### TECHNICAL FIELD

The present invention relates to a mixer control device and a system for controlling a mixer based on manufacturing instructions data for each specified product and data concerning particular manufacturing conditions relating to a product, including any semi-manufactured product that is used in manufacturing the product.

### BACKGROUND ART

In mixing the materials for making bread and similar products, which are mainly made of wheat flour, it is not easy to maintain the dough at a constant finishing temperature as changes occur in such conditions as (1) the temperature of the room in which the manufacturing is conducted (hereinafter “the room”), (2) the temperatures of the main raw materials, (3) the temperature of the feed water, (4) the humidity of the room's air, (5) the feed amounts of the materials, and so on. Under such conditions, the automatic control of mixing so as to maintain the dough at a constant finishing temperature—by means of adjusting the mixer's rotation speed, rotation time, water-absorption amount, and so on—has been sought.

One example of such an automatic control system of a mixer is disclosed on pages 1-6 in “Control Method and Device for Mixing Bread Dough of Japanese Unexamined Patent Application Publication No. 2001-275550; however, control of the mixer's rotation speed and rotation time according to the feed amount of dough is not provided there. Furthermore, that example deals only with changes of the mean temperature of bread dough during mixing corresponding to changes in the manufacturing environment and fails to provide any measures for adjusting the process in response to changes of the feed-water temperature or changes in the humidity of the air of the room. Accordingly, that example contains a problem that the finishing temperatures of the dough vary.

Patent Document 1: Japanese Unexamined Patent Publication No. 2001-275550, pages 1-6.

### DISCLOSURE OF THE INVENTION

### Problems to be Solved by the Invention

In order to eliminate the above-mentioned problems, the present invention provides a mixer control device for controlling a mixer used in manufacturing a product, including any semi-manufactured product that is used in manufacturing the product, by setting the feed-water temperature based on correction data corresponding to changes of such manufacturing conditions as (1) the feed amounts of raw materials, (2) changes in the temperatures of (a) the room, (b) the respective main raw materials, and (c) the feed water, (3) the humidity of the room's air, and so on. The present invention further provides a mixer control system that automatically controls a mixer to manufacture finished products at target finishing temperatures by providing, in real time, control instructions to the mixer according to the feed amounts of raw materials, changes in the manufacturing conditions such as those just mentioned.

### Means for Resolving the Problems

In order to achieve the above-mentioned objectives, claim 1 of the present invention provides for a mixer control device that controls a mixer, based on the manufacturing instructions data for a specific product, including a semi-manufactured product, and the data concerning the particular manufacturing conditions, and that consists of

(1) a sensor for obtaining manufacturing-conditions data, including at least the temperatures of the raw materials, the temperature of the room, and the temperature of the product being manufactured, and changes in such manufacturing-conditions during manufacturing;

(2) a manufacturing-conditions-data acquisition means that receives the manufacturing-conditions data from said sensor;

(3) correction data for correcting the feed-water temperature based on said obtained manufacturing-conditions data;

(4) a feed-conditions setting means that, based on said correction data and according to the feed amounts of the raw materials, sets the feed conditions, including at least the mixing time of said mixer and the feed-water temperature of the product being manufactured;

(5) a mixer control means that controls said mixer based on said feed conditions.

In said mixer control device according to Claim 2,

said correction data consists of correction values for
(a) the temperatures of the raw materials at the time of mixing, and
(b) the mixing time for said mixer, with said correction values corresponding to
(i) the weights of the raw materials,
(ii) the temperatures of the raw materials, and
(iii) the temperature of the room,
   and said feed-conditions setting means consists of a feed-water-temperature calculation means, which calculates the feed-water temperature in order to obtain a desired finishing temperature of the product based on said correction values.

The mixer control system according to Claim 3 of the present invention, which, based on the manufacturing instructions data for particular products and the manufacturing-conditions data for each particular product, including semi-manufactured products, exerts centralized control over each of multiple mixers, consists of

(1) a mixer for manufacturing products,

(2) a control unit that controls said mixer,

(3) a sensor for obtaining a variety of manufacturing-conditions data, including the temperatures of the product and the feed-water, with said sensor connected to said control unit,

(4) a manufacturing terminal that provides instructions for manufacturing particular products, and

(5) a control management unit that transmits control data for said mixer to said control unit, based on instructions from said manufacturing terminal, with said control management unit being connected to said control unit and said manufacturing terminal via a communications network,

wherein

[1] said control unit includes a manufacturing-conditions-data transmission means for transmitting the manufacturing-conditions data obtained by said sensor to said control management unit,

[2] said control management unit includes [a] a database for registering control-instruction information, including mixing conditions such as the rotation speed, rotation time, and so on for said mixer, along with a variety of correction data according to the manufacturing conditions for each product by name, by the name of each raw material used, and by each step of the manufacturing process, [b] a manufacturing-instructions-data acquisition means that receives from said manufacturing terminal manufacturing-instruction data, including product names, the names of raw materials, and the feed amount of each raw material, [c] a manufacturing-conditions-data receiving means that receives the manufacturing-conditions data from said control unit, [d] a control-data creation means that creates control data by [i] searching said database using the manufacturing instructions data obtained by said manufacturing-instructions-data acquisition means and the manufacturing-conditions data received by said manufacturing-conditions-data receiving means, and [ii] obtaining said correction data, and [e] a control-data transmission means that transmits to said control unit the control data created by said control-data creation means, and

[3] said control unit includes a control-data receiving/controlling means that receives control data from said control management unit and that controls said mixer based on the control data.

According to Claim 4,
said correction data consists of the correction values of
   (a) the temperature of the raw materials at the time of mixing, and
   (b) the mixing time for said mixer,
with said correction values corresponding to
   (i) the weights of the raw materials,
   (ii) the temperatures of the raw materials, and
   (iii) the temperature of the room,
and said correction values are intended to correct the feed-water temperature, based on the manufacturing-conditions data received,
and said control-data creation means consists of

(1) a feed-water-temperature calculation means, which calculates the feed-water temperature in order to obtain a desired finishing temperature of the product based on said correction values, and

(2) a feed-conditions setting means, which sets the feed conditions, including at least the mixing time of said mixer and the feed-water temperature of the product, according to the feed amounts of the raw materials based on said correction data.

According to Claim 5,

(1) said database consists of
(a) control instruction information, which consists of the rotation speed and the rotation time of said mixer by [1] the name of each particular product, [2] the name of each raw material used, and [3] each step of the manufacturing process,
(b) correction information for
   each feed amount, which consists of the corrected rotation time for each product by [a] its name, [b] the name of each raw material used, and [c] the preset amount of each raw material used, and
   each feed-water temperature, with said correction information consisting of the corrected rotation time for each predetermined feed-water temperature;

(2) said control-data creation means
(a) searches said database by using
   the product names, the names of raw materials, and the feed amounts of the raw materials obtained by said manufacturing-instructions-data acquisition means, obtaining said control-instruction information and correction information for each feed amount,
   the feed-water temperature of the manufacturing-conditions data received by said manufacturing-conditions-data receiving means, obtaining said correction information for each feed-water temperature, and
(b) calculates the total corrected rotation time by adding
   [1] the corrected rotation time of the obtained correction information for each feed amount, and
   [2] the corrected rotation time of the obtained correction information for each feed-water temperature, and
(c) creates control data, including the calculated rotation time obtained by multiplying the rotation time of said control-instruction information by the normalized value obtained by dividing the calculated total corrected rotation time by the predetermined rotation time for each step of the manufacturing process.

According to Claim 6,

(1) said manufacturing-conditions data includes data concerning changes in the temperature of the product during the manufacturing process,

(2) said control instruction information includes the target finishing temperature for the particular product, and

(3) said control-data creation means searches for the corrected rotation time corresponding to the value calculated by dividing the difference of the temperature by the preset temperature in said database if the temperature of the product in the manufacturing-conditions data during the manufacturing process fails to reach the target temperature when the making of the particular product has been completed, and creates the control data for further production by further adjusting the corrected rotation time according to the preset rotation speed for the manufacturing process.

According to Claim 7,

(1) said manufacturing-conditions data further includes the humidity of the room's air;

(2) said database further includes recipes information consisting of the standard usages of the raw materials, including the feed water, when supplying said mixer with the raw materials for a product, and

(3) said control-data creation means further includes a log-information registration means, which creates log information by adding the manufacturing-conditions data, including the humidity of the room's air information, to said control data, and registers the log information into the database;

(4) said control management unit
(a) includes a means of registering the mean-humidity of the room's air, with said humidity-registering means obtaining, by searching said database, the log information that was registered on that day,
(b) supplements the mean-humidity of the room's air by calculating said mean-humidity by using obtained log information, and registers the mean-humidity of the room's air with the recipe information;

(5) said control-data creation means
(a) obtains the corresponding recipe information by searching said database by using the product name in the manufacturing instructions data obtained by said manufacturing-instructions-data acquisition means,
(b) subtracts the manufacturing-conditions data regarding the humidity of the room's air from the mean humidity of the room's air of the recipe information obtained, so as to calculate the difference between those two values,
(c) searches for the corresponding correction value using the value obtained by dividing the calculated difference in the humidity of the room's air by the desired humidity of the room's air at set forth in said database, and
(d) creates control data by adding the corresponding correction value to the standard usage of the feed water of said recipe information.

According to Claim 1 and Claim 2 of the present invention, because the feed-water temperature is set so as to maintain constant finishing temperatures of products by obtaining manufacturing-conditions data, including the feed amounts of raw materials and the temperatures of the raw materials and the temperature of the room, and referring to the correction data that corresponds to the manufacturing-conditions data, finished products having a constant quality can be manufactured without the need for skilled personnel.

According to Claim 3 through Claim 7 of the present invention, even if correction data corresponding to the temperatures of the raw materials or the conditions of the manufacturing environment is not available in advance, products having a constant finishing temperature can be manufactured by automatically adjusting the rotation speed and the rotation time of the mixer according to the feed amounts of the raw materials and the feed-water temperature.

Further, finished products meeting the target finishing temperature can be manufactured by automatically adding an additional manufacturing step appropriate for the varying temperatures of products.

In addition, to deal with daily variations in the humidity of the room's air, superior-quality products can be manufactured by automatically adjusting the recipe according to the feed-water amount that corresponds to the aforementioned difference in the humidity of the room's air.

### Advantageous Effects of the Invention

According to the mixer control device of the present invention, in the manufacturing process of mixing, products of consistent quality can be manufactured continuously by calculating the feed-water temperature based on correction data corresponding to the manufacturing conditions, such as the feed amounts of raw materials, the respective temperatures of the main raw materials, the temperature of the room, and so on.

According to the mixer control system of the present invention, even if correction data corresponding to the aforementioned temperatures or other conditions are not available in advance, finished products having the target finishing temperature can be manufactured by providing automatic control instructions to the mixer in real time according to changes in the manufacturing conditions, such as the feed amounts of raw materials, the respective temperatures of the main raw materials, the feed-water temperature, the temperature of the room, the humidity of the room's air, and so on.

### BRIEF DESCRIPTION OF THE DRAWINGS

FIG. 1 is a block diagram of a mixer control device according to an embodiment of the present invention.

FIG. 2 is an explanatory diagram showing four types of correction data (a) to (d) of the mixer control device of FIG. 1.

FIG. 3 is a block diagram of a mixer control system according to an embodiment of the present invention.

FIG. 4 is a flowchart showing the mixer control system process of FIG. 3.

### EXPLANATION OF REFERENCE NUMERALS

1. Mixer control device

### 2. Mixer

### 3. Sensor

4. Manufacturing terminal

### 5. The Internet

10. Control unit
12 Correction data table
13 Manufacturing-conditions-data acquisition means
14 Feed-water temperature calculation means
20. Processing means of control unit
21. Manufacturing-conditions-data transmission means
22. Control-data receiving/controlling means
30. Control management unit
31. Web server
32. Database server
33. Application server

### 40. Database

41. Manufacturing terminal table
42. Control instructions table
43. Correction table for each feed amount
44. Correction table for each feed-water temperature
45. Recipes table
46. Log table
50. Control-management-unit processing means
51. Manufacturing-instructions-data acquisition means
52. Manufacturing-conditions-data receiving means
53. Control-data creation means
54. Control-data transmission means
55. Mean room-air-humidity registration means
100. Mixer control system

### BEST MODES FOR CARRYING OUT THE INVENTION

The best modes for actualizing the invention will now be explained, referring to the aforementioned drawings.

### Embodiment 1

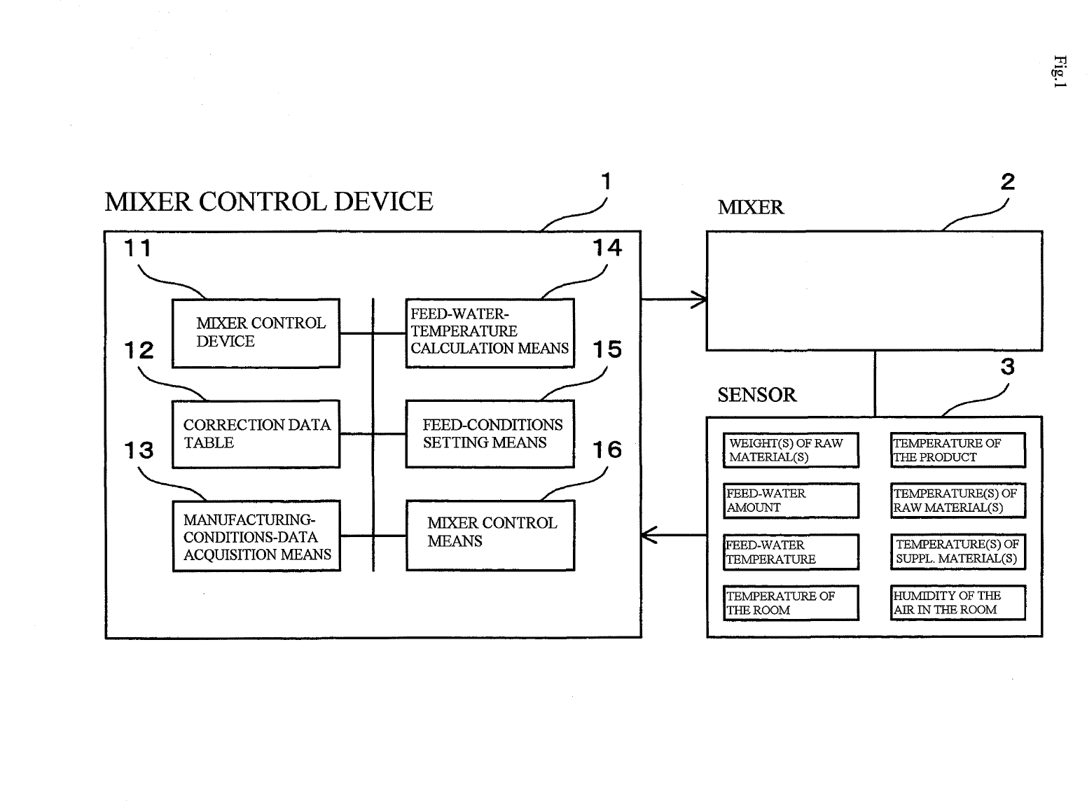

FIG. 1 is a block diagram of a mixer control device according to an embodiment of the present invention, and in said diagram

1 is the mixer control device;

2 is a mixer controlled by the mixer control device 1; and

3 is a sensor for obtaining the temperatures of the raw materials, the temperature of the room, and the temperature of the product, along with changes in such temperatures. Said sensor obtains the temperature of each raw material before feeding, the product's temperature and changes thereof after feeding, the temperature(s) of supplementary material(s) added to the main raw materials, the ambient environment's temperature (temperature of the room), the humidity of the manufacturing environment's air (room humidity), and so on. In addition, the sensor also monitors the weight of the raw materials, the feed-water amount, and the temperatures thereof in the process of manufacturing the product.

Although the mixer control device 1 can be configured by using a sequencer, which is not equipped with a CPU, Embodiment 1 uses a CPU for controlling the mixer. In FIG. 1,

1 is a main control unit equipped with a CPU, and 12 is a Correction data table that includes correction data for calculating and setting the feed-water temperature based on the manufacturing-conditions data obtained from the sensor 3, in order to obtain a constant finishing temperature of products being manufactured;

13 is a manufacturing-conditions data acquisition means for obtaining manufacturing-conditions data such as the temperatures of raw materials, the room, the product, and so on;

14 is a feed-water-temperature calculation means that calculates the appropriate feed-water temperature, which allows the products to achieve the desired finishing temperature according to the manufacturing instructions, by referring to the Correction data table that incorporates the obtained manufacturing-conditions data, thereby obtaining correction values including mixing time corresponding to the weight and temperatures of the raw materials and the like, substituting into a predetermined formula the mixing data (such as the amounts of raw materials, the feed-water amount, the mixing time, and so on), the amount of heat generated at the target finishing temperature, and obtained correction values.

For some products the manufacturing process includes multiple feeding procedures, wherein the rotation speed and the rotation time of the mixer are required to be specified for each specific product to be manufactured. Accordingly, when multiple manufacturing process are included, each manufacturing process utilizes correction data corresponding to the process's respective temperatures and mixing time (rotation time). Although the weights of the raw materials and the feed-water amount can be specified in advance of manufacturing the products, the sensor also monitors the weights of the raw materials, the feed-water amount, and the feed-water temperature, and sensor-derived information can be used in adjusting the mixing process.

In FIG. 1, 15 is a feed-conditions setting means for setting control-instruction data, including the feed-water temperature as calculated by the feed-water-temperature calculation means, and the mixing time, and 16 is a mixer control means that transmits data set by the feed-conditions setting means and that controls the mixer.

Illustrations and configuration drawings regarding other elements in the mixer control device—such as the CPU; the storage means, including ROM or RAM; control programs stored in the ROM and so on for executing each means thereof by using the CPU; a control panel for providing manufacturing instructions to the mixer; the mixing process in the manufacturing process; and equipment for monitoring the temperature an so on—are omitted.

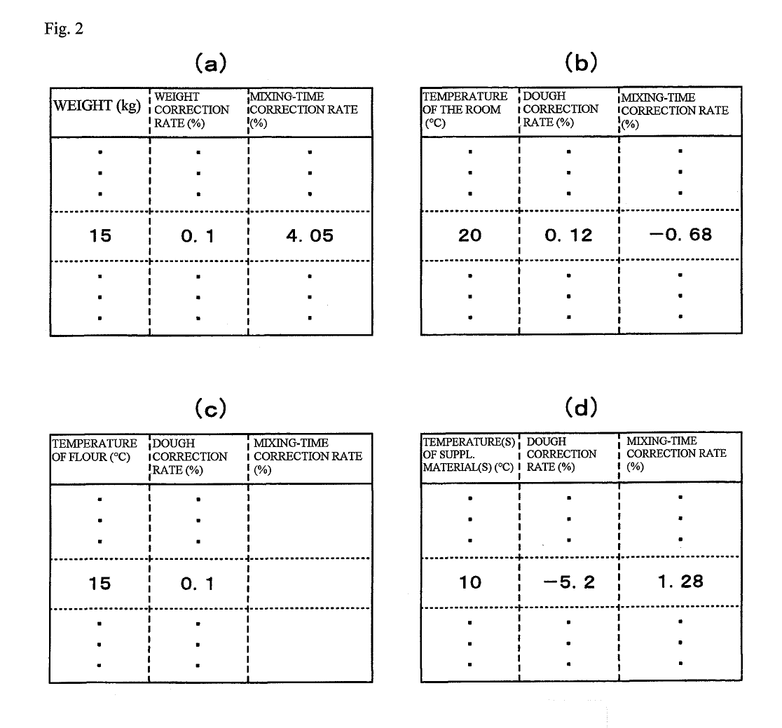

In FIG. 2, tables (a) to (d) show examples of correction data registered on the Correction data table 12, with the data for each mixer and each product being registered in advance as characteristic values. Table (a) presents correction values for the feed weights of raw materials, and said table contains correction values according to the temperature of a raw-material (dough) by kilogram for the weight-correction rate as well as the correction values for the mixing time. Table (b) presents dough-correction values according to the temperature of the room, and said table contains the correction values according to the temperature, in terms of centigrade degrees, of the raw material (dough) and the correction values for the mixing time thereof. Likewise, Table (c) represents the correction values according to the temperature of the dough (flour), and Table (d) represents the correction values according to the temperatures of subsidiary materials and semi-manufactured products being added to the main raw material; the correction values for semi-manufactured products are used as correction data when, for example, multiple procedures are required for manufacturing a product and subsidiary materials undergoing fermentation are incorporated as semi-manufactured products while the manufacturing process is underway. The correction data is obtained by multiplying correction coefficients corresponding to the amount or proportion of the subsidiary materials by the weight or the temperature of the raw materials and the semi-manufactured products.

### Embodiment 2

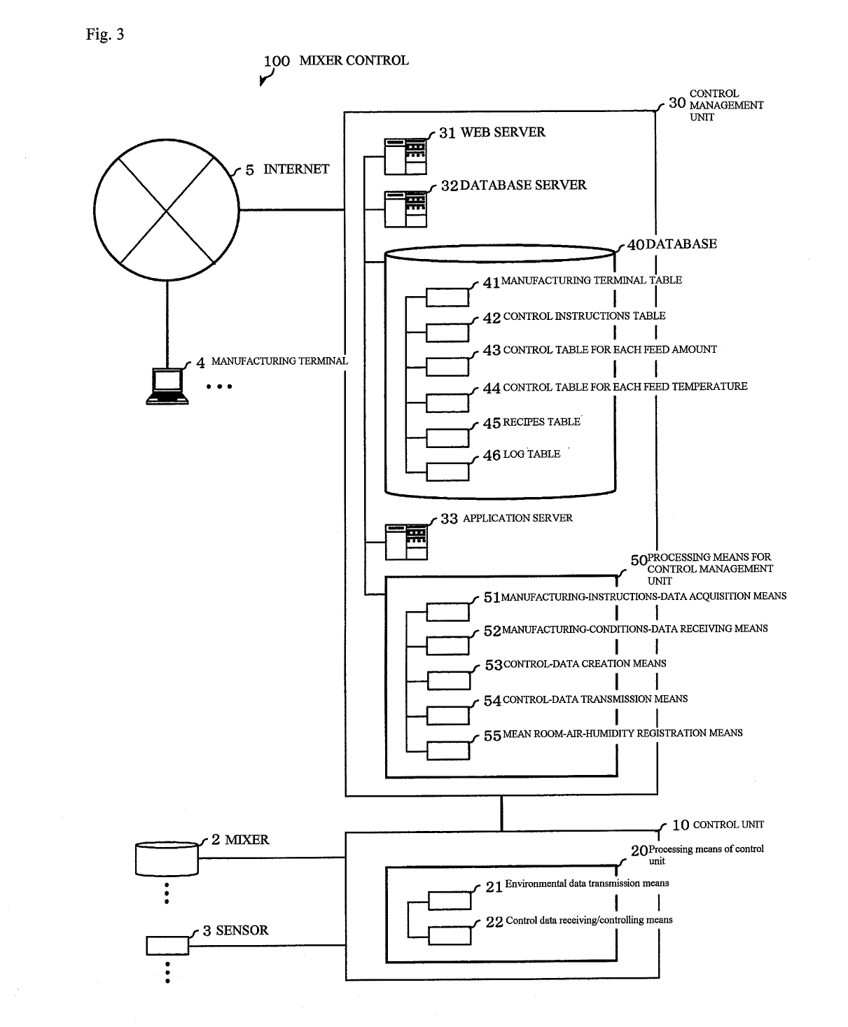

FIG. 3 is a block diagram of a mixer control system according to another embodiment of the present invention. The configuration and operation thereof will now be explained, referring to that drawing.

As shown in FIG. 3, the mixer control system 100 includes

a manufacturing terminal 4 for providing instructions for manufacturing products, including semi-manufactured products;

a mixer 2 for manufacturing such products;

a control unit 10, which is connected to the control management unit 30 for controlling the mixer 2;

a sensor 3, which is connected to the control unit 10, and which obtains manufacturing-conditions data, including the feed-water temperature, the temperature of the product being manufactured, and the humidity of the room, along with changes in such data as they occur; and

a control management unit 30, which (1) is connected to the manufacturing terminal 4 via the Internet 5, (2) creates control data for the mixer 2, based on the manufacturing instructions received from the manufacturing terminal 4, and (3) is connected to the control unit 10, to which it transmits the control data.

In this case, the manufacturing terminal 4 can be configured so as to provide manufacturing instructions to multiple mixers 2, and the control unit 10 also can be configured so as to control multiple mixers 2. In addition, the control management unit 30 can of course be configured so as to provide for centralized management by connecting multiple locations of a manufacturer by using a communications network, and such communications network are not limited to the Internet, with the result that the communications network can use LANs and other means so as, for example, to centrally control multiple mixers 2 and multiple control units 10 at multiple locations within a factory. The manufacturing terminal 4 and the control management unit 30 can use commercially available PCs (personal computers), workstations, Web servers, and/or database servers, and the particular communications means are realized by executing predetermined programs implemented on such PCs, workstations, and the like. Omitted from the drawings relating to this embodiment are illustrations and configuration drawings regarding CPUs (central processing units), being elements of PCs and workstations; storage devices (including memory chips or hard disks); devices that display images, texts, or other content; input devices, including keyboards, mice, and so on; input/output devices associated with a communications network; and other external devices that are connected to the communications network.

Embodiment 2 represents only a configuration for automatically controlling the mixer so as to maintain constant finishing temperatures of products, using manufacturing-conditions data obtained in real time from the manufacturing processes, when such processes require multiple procedures to manufacture products, and omitted from the drawings relating to this embodiment are illustrations regarding a configuration that sets the feed-water temperature so as to maintain constant finishing temperatures of products, based on correction data according to the manufacturing-conditions data registered in the database in advance; such illustrations are provided by Embodiment 1.

The control management unit 30 includes

a database 40 in which is registered information required for creating the control data for controlling the mixer 2;

a Web server 31, which receives search requests from a manufacturing terminal 4 and transmits the search results from the database 40 via the Internet 5;

a database server 32, which manages the database 40; and

an application server 33, which implements the respective means of the control-management-unit processing means 50—i.e., the manufacturing-instructions-data acquisition means 51, the manufacturing-conditions-data receiving means 52, the control-data creation means 53, the control-data transmission means 54, and the mean-room-air-humidity registration means 55—for controlling the mixer 2.

The database 40 includes the following statistical tables:

a Manufacturing terminal table 41 that specifies which manufacturing terminal 4 is being controlled;

a control instructions table 42 for the control unit 10;

a correction table for each feed amount 43 of the raw materials;

a correction table for each degree level of feed-water temperature 44;

a recipes table 45 that relates the amount of the raw materials used to the feed-water amount; and

a log table 46, which records the manufacturing-conditions data, including various types of information relating to the manufacturing process, the humidity of the room's air, and so on.

The registration information of the manufacturing terminal 4 is recorded on the Manufacturing terminal table 41. The manufacturing-terminal registration information, which consists of a search key division, which is composed of a user ID and a password and that includes the mixer number, and a data division, which includes the name of a business establishment; the business's relevant department; the name of the person in charge of the department; the business's address, telephone number, and e-mail address; manufacturing instructions data, and date of registration of the data.

The manufacturing instructions data includes the name of the product being manufactured, the names of the main raw materials, the feed amounts, and so on.

Control instruction information for creating control data for the mixer 2 is recorded on the control instructions table 42.

The control instruction information consists of a search key division, which is composed of the product name and the names of the main raw materials, and a data division, which includes the rotation speed (1), rotation time (1), rotation speed (2), rotation time (2), rotation speed (3), rotation time (3), rotation speed (4), and rotation time (4) for each manufacturing process of multiple processes; the target finishing temperature of a finished product; date of registration of the data; and so on.

In the above description of the control instruction information, the numbers in parentheses represent each step of the manufacturing process, wherein low rotation speeds of the mixer 2 are set at rotation speed (1) and rotation speed (3), and high rotation speeds of the mixer 2 are set at rotation speed (2) and rotation speed (4). The rotation time is set in seconds.

For the purpose of correcting the rotation time of the control instruction information according to the predetermined feed amounts of the main raw materials, the correction information for each feed amount is recorded on the correction table for each feed amount 43. The correction information for each feed amount consists of a search key division that contains the product name, the name of main raw materials, and the predetermined feed amount of the raw materials, and a data division that includes corrected rotation times, date of registration of the data, and so on. The corrected rotation time is set in time intervals of one second, including a plus (+) or minus (−) sign, as appropriate.

The correction information for each feed-water temperature for correcting the rotation time of the control instruction information according to the preset feed-water temperature is recorded on the correction table for each feed-water temperature 44. The correction information for each feed-water temperature consists of a search key division, which contains the preset feed-water temperature, and a data division, which includes the corrected rotation times, date of registration of the data, and so on. The corrected rotation time is set in time intervals of one second, including a plus (+) or minus (−) sign, as appropriate.

The recipe information used in order to supply the mixer 2 with the raw materials required for manufacturing specific products is recorded on the recipes table 45. The recipe information consists of a search key division, which contains the product name and the names of the raw materials, and a data division, which includes the standard uses of each raw material, the mean humidity of the room, date of registration of the data, and the like. For the names of the raw materials, “the names of the main raw materials,” “the names of the supplementary materials,” “feed water,” and the like are set. If “feed water” is set as the name of a raw material, that means that the humidity of the room's air is set.

Log information created by supplementing the manufacturing-conditions data transmitted by the manufacturing-conditions-data transmission means 21 to the control data created by a control-data creation means 53 described below is recorded on the log table 46. The log information consists of a search key division that consists of the date and time of creation of the log information and the mixer number, and a data division that includes the sensor number, the data obtained by the sensor, the rotation speed, the rotation time, date of registration of the sensor data, and so on. The feed-water temperature, the temperature of the product during the manufacturing process, the humidity of the room's air, and so on are adjusted according to the data obtained by the sensor.

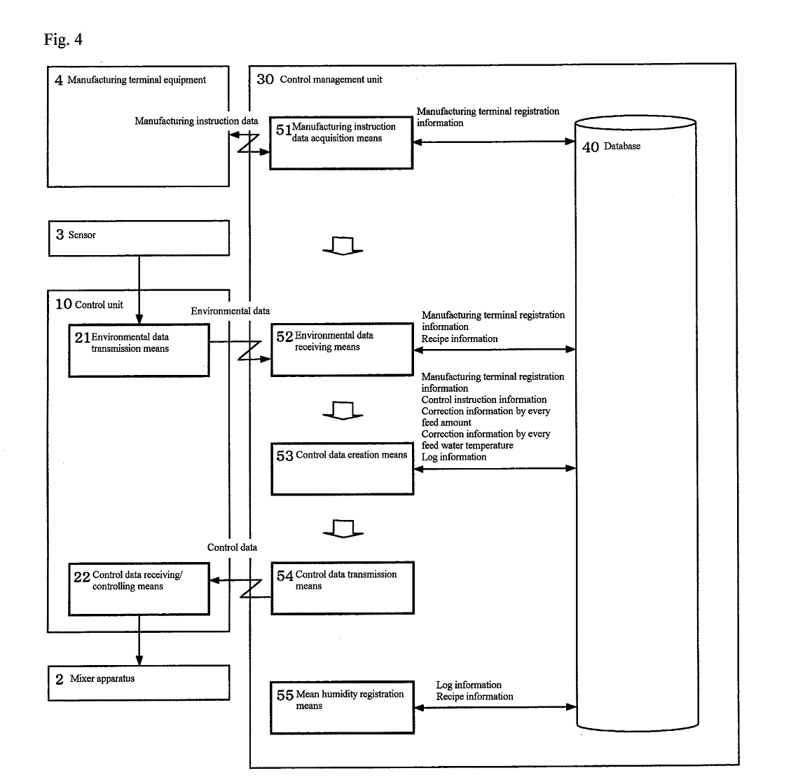

Next will be provided explanations of the procedures of transmitting and receiving data between the control unit 10 and the control management unit 30 and the procedures used by the processing means 50 of the control management unit 30 in searching the database 40 in response to request signals from the manufacturing terminal 4. FIG. 4 is a flow chart showing the procedures of the processing means 20 of the control unit 10 and the processing means 50 of the control management unit 30, with the processing means illustrated on FIG. 4 being composed of the following seven means.

The seven means are the manufacturing-instructions-data acquisition means 51, the manufacturing-conditions-data transmission means 21, the manufacturing-conditions-data reception means 52, the control-data creation means 53, the control-data transmission means 54, the control-data receiving/controlling means 22, and the mean room-air-humidity registration means 55.

First, the user ID and the password input at the manufacturing terminal 4 are received by the control management unit 30 so as to authenticate the user; if the user of the manufacturing terminal is registered as a user of the system, a menu selection screen is transmitted to the manufacturing terminal 4.

The manufacturing-instructions-data acquisition means 51 receives from the manufacturing terminal 4 the manufacturing instructions data, including the name of the product to be manufactured, the name of the main raw materials required for manufacturing the product, and the feed amounts of the main raw materials.

The operation of the manufacturing-instructions-data acquisition means 51 will now be explained. The manufacturing-instructions-data acquisition means 51

(1) Responds to a request signal for manufacturing instructions data and transmits to the requesting manufacturing terminal 4 the manufacturing-instruction data acquisition/product-name selection screen—on which the product name list to be manufactured is displayed;

(2) Receives from the manufacturing terminal 4 the product name selected and transmits to the requesting manufacturing terminal 4 the manufacturing-instruction data acquisition/feed-amount selection screen—on which are displayed the list of the name(s) of main raw materials and the feed amounts thereof, based on the product name selected;

(3) Receives from the manufacturing terminal 4 the feed amounts selected and obtains the manufacturing-terminal registration information by searching the Manufacturing terminal table 41 using the user ID and password that have been input and received when authenticating the right to use; and

(4) Updates the manufacturing-terminal registration information of the Manufacturing terminal table 41 by supplementing the manufacturing-instruction data, including the product name and the name(s) of the main raw materials selected in step (2) and the feed amounts selected in step (3).

The manufacturing-conditions-data transmission means 21 transmits to the control management unit 30 the manufacturing-conditions data obtained by the sensor 3.

The procedures of the manufacturing-conditions-data transmission means 21 will now be explained.

(1) Based on the feed water and the main raw materials put into the mixer 2, the sensor 3 obtains, if required, the feed-water temperature, the respective temperatures of the main raw materials, and the humidity of the room's air.

(2) The manufacturing-conditions-data transmission means 21 creates the manufacturing-conditions data, including the data classification of the data obtained by the sensor 3 by step (1), the various temperatures obtained by the sensor 3, the humidity of the room's air, and the predetermined mixer number, and transmits such manufacturing-conditions data to the control management unit 30.

The manufacturing-conditions-data receiving means 52 receives the manufacturing-conditions data from the control unit 10. If the manufacturing-conditions data includes the humidity, the manufacturing-conditions-data receiving means

searches the database 40 to obtain the appropriate recipe information by using the product name of the manufacturing instructions data received from the manufacturing-instructions-data acquisition means 51;

calculates the difference in the humidity of the room's air by subtracting the humidity of the room's air of the manufacturing-conditions data received from the mean room-air humidity of the recipe information obtained;

obtains the appropriate correction data from the database 40 based on the value obtained by dividing the calculated room-air humidity difference by the desired humidity, and

adds the corresponding correction data to the feed water's standard usage in the recipe information.

The operation of the manufacturing-conditions-data receiving means 52 will now be explained.

The manufacturing-conditions-data receiving means 52

(1) Remains in a standby mode until receiving manufacturing-conditions data from the control unit 10;

(2) Transfers to the control-data creation means 53 the manufacturing-conditions data received by step (1) after terminating the standby mode;

(3) Obtains the corresponding manufacturing-terminal registration information by searching the Manufacturing terminal table 41 using the predetermined mixer number, if the data classification of the obtained by the sensor 3 is humidity;

(4) Searches the recipes table 45 using the product name in the manufacturing-terminal registration information that has been obtained and the names of the raw materials for which “the feed water” is set, and obtains the corresponding recipe information;

(5) Calculates the difference in the room-air humidity by subtracting the humidity of the room's air in the manufacturing-conditions data received by step (1) from the mean room-air humidity in the recipe information obtained by step (4); and

(6) Obtains the corresponding correction data from the database 40 based on the value obtained by dividing the room-air-humidity difference calculated by step (5) by the desired room-air humidity (here the integral part of the quotient is used), and updates the recipes table 45 by adding that correction data to the standard usage of the feed water in the recipe information obtained by step (4).

The control-data creation means 53

searches the database 40 by using the product name of the manufacturing instructions data obtained by the manufacturing-instructions-data acquisition means 51, the names of main raw materials, and the feed amounts of the main raw materials, and obtains the corresponding control-instruction information and correction information for each feeding amount, and then

obtains the corresponding correction information for each feed-water temperature by searching the database 40 by using the feed-water temperature of the manufacturing-conditions data received by the manufacturing-conditions-data receiving means 52.

The control-data creation means 53 further calculates the total corrected rotation time by adding the corrected rotation time obtained from the correction information for each feed amount to the corrected rotation time obtained from the corrected information for each feed-water temperature, and creates control data, including the calculated rotation time obtained by multiplying the rotation time of the control instruction information by the value obtained by normalizing the calculated total corrected rotation time using the preset rotation time for each step of the manufacturing process.

Furthermore, if the temperature of the product being manufactured received by the manufacturing-conditions-data receiving means 52 fails to reach the target finishing temperature for the finished product, the control-data creation means 53 searches the corrected rotation time in the database corresponding to the value obtained by dividing the difference of the actual temperature by the desired temperature and creates the control data by further adjusting such corrected rotation time according to the preset rotation speed for the manufacturing process.

In addition, the control-data creation means 53 creates log information by adding the manufacturing-conditions data to the control data and subsequently enters that log information in the database 40.

The operation of the control-data creation means 53 will now be explained.

The control-data creation means 53

(1) Remains in a standby mode until receiving the manufacturing-conditions data from the manufacturing-conditions-data receiving means 52;

(2) Obtains the corresponding manufacturing-terminal registration information by searching the Manufacturing terminal table 41 by using the mixer number of the manufacturing-conditions data received in step (1) after terminating the standby mode;

(3) Obtains the corresponding control instruction information by searching the control instructions table 42 by using the product name and the name of the main raw materials obtained from the manufacturing-terminal registration information by step (2),

(4) Obtains the corresponding correction information for each feed amount by searching the correction table for each feed amount 43 by using the product name, the name of main raw materials, and the feed amounts obtained from the manufacturing-terminal registration information by step (2);

(5) Searches the correction table for each feed-water temperature using the feed-water temperature of the manufacturing-conditions data received in step (1) and obtains the corresponding correction information for each feed-water temperature;

(6) Calculates the total corrected rotation time by adding the corrected rotation time of obtained correction information for each feed amount obtained in step (4) to the corrected rotation time of the correction information for each feed-water temperature obtained in step (5);

(7) Normalizes the total corrected rotation time by using the preset rotation time, and creates the control data, including the rotation time calculated by multiplying the rotation time of the control instruction information obtained by step (3) for each step of the manufacturing process by the normalized value obtained by dividing the total corrected rotation time by the predetermined rotation time;

(8) Searches the database for the corrected rotation time corresponding to the value calculated by dividing the difference between (a) the target finishing temperature, which is included in the control instruction information obtained in (3) above, and (b) a product's temperature obtained by the sensor 3, as registered subsequently by the preset temperature and creates control data that further adjusts the corrected rotation time based on the manufacturing process's preset rotation speed if the classification of the manufacturing-conditions data obtained by the sensor 3 in step (1) is the temperature of a product in the manufacturing process and if the temperature fails to reach the finished product's target temperature as set forth on the control instruction information obtained in step (3) [For example, assuming that the step of the manufacturing process is (5), the rotation speed (5) and the rotation time (5) are created.];

(9) Creates log information by adjusting the manufacturing-conditions data received in step (1) based on the control data created in steps (7) and (8), and enters such information on the log table 46; and

(10) Transfers to the control-data transmission means 54 the control data created by steps (7) and (8).

The control-data transmission means 54 transmits to the control unit 10 the control data created by the control-data creation means 53.

The operation of the control-data transmission means 54 will now be explained. The control-data transmission means 54

(1) Remains in a standby mode until receiving control data from the control-data creation means 53; and

(2) Transmits to the control unit 10 the control data received in step (1) after terminating the standby mode.

The control data receiving/controlling means 22 receives control data from the control management unit 30 and controls the mixer 2 based on such control data.

The operation of the control data receiving/controlling means 22 will now be explained.

The control data receiving/controlling means 22

(1) Remains in a standby mode until receiving the control data from the control-data transmission means 54, and

(2) Controls the mixer 2 based on the control data received in step (1) after terminating the standby mode.

The mean room-air-humidity registration means 55 obtains the log information registered on that day by searching the database 40, calculates the mean room-air humidity by using the log information, and supplements the recipe information with the calculated mean room-air humidity so as to register such mean room-air humidity with the recipe information.

The operation of the mean room-air humidity registration means 55 will now be explained.

The mean room-air humidity registration means 55

(1) Upon finishing the daily processing work, searches the log table 46 by using that day's date, extracts the log-information sets of that day by using the date of creation of the log information, and calculates the mean room-air humidity by aggregating the humidity of the room's air for each mixer number; and

(2) Sets the mean room-air humidity calculated in step (1) with the recipe information where “feed water” is set as the name of a raw material, by searching the recipes table 45, and updates the recipes table 45 by setting the mean room-air humidity.

Although the preferred embodiments of the present invention have been described in detail, the invention is not limited to such embodiments. Various modifications of the described embodiments are possible without departing from the spirit and scope of the present invention.

### INDUSTRIAL APPLICABILITY

The mixer control device of the present invention is capable of continuously manufacturing products of consistent quality by calculating the feed-water temperature based on correction data relating to the feed amounts of products and changes in the manufacturing conditions. such as the respective temperatures of the main raw materials, the temperature of the room, and so on. Even when correction data relating to the manufacturing conditions are not available in advance, the mixer control system of the present invention is capable of manufacturing finished products having a target finishing temperature by providing to the mixer, in real time, automatic control instructions corresponding to the feed amounts of raw materials, changes in the manufacturing conditions, such as the respective temperatures of the main raw materials, the feed-water temperature, the temperature of the room, the humidity of the room's air, and so on.

What is claimed is:

1. A mixer control device that controls a mixer, based on the manufacturing instructions data for a specific product, including a semi-manufactured product, and the data concerning the particular manufacturing conditions, and that consists of:
a sensor for obtaining manufacturing-conditions data, including at least the temperatures of the raw materials, the temperature of the room, the temperature of the product being manufactured, and changes in such manufacturing-conditions during manufacturing;
a manufacturing-conditions-data acquisition means that receives the manufacturing-conditions data from said sensor;
correction data for correcting the feed-water temperature based on said obtained manufacturing-conditions data;
a feed-conditions setting means that, based on said correction data and according to the feed amounts of the raw materials, sets the feed conditions, including at least the mixing time of said mixer and the feed-water temperature of the product being manufactured; and
a mixer control means that controls said mixer based on said feed conditions.

2. A mixer control device according to claim 1, wherein
said correction data consists of correction values for
the temperature of the raw materials at the time of mixing, and
the mixing time for said mixer,
with said correction values corresponding to
the weights of the raw materials,
the temperatures of the raw materials, and
the temperature of the room; and
said feed-conditions setting means consists of a feed-water-temperature calculation means, which calculates the feed-water temperature in order to obtain a desired finishing temperature of the product based on said correction values.

3. A mixer control system for automatically controlling a mixer based on the manufacturing instructions data for each product and on the manufacturing-conditions data of the manufacturing environment for manufacturing products, including semi-manufactured products, using a mixer, with said mixer control system consisting of:
a mixer for manufacturing products;
a control unit for controlling said mixer;
a sensor that is connected to said control unit and that obtains a variety of manufacturing-conditions data, including the temperature of the product being manufactured and the feed-water temperature;
a manufacturing terminal for providing instructions for manufacturing specific products; and
a control management unit that transmits control data for said mixer to said control unit, based on the instructions from the manufacturing terminal, and that is connected to said control unit and said manufacturing terminal via a communications network,
wherein
said control unit includes
a manufacturing-conditions-data transmission means for transmitting to said control management unit the manufacturing-conditions data obtained by said sensor; and
said control management unit includes
a database in which to register control instruction information, including mixing conditions such as rotation speed, rotation time, and so on for said mixer, and a variety of correction data corresponding to the manufacturing conditions and complied by each product's name, by the names of all raw materials used, and by each step of the manufacturing process;
a manufacturing-instructions-data acquisition means that receives from said manufacturing terminal manufacturing instructions data, including product names, the names of raw materials, and the feed amounts of the raw materials;
a manufacturing-conditions-data receiving means that receives manufacturing-conditions data from said control unit; and
a control-data creation means that creates control data by searching said database by using the manufacturing instructions data obtained by said manufacturing-instructions-data acquisition means and the manufacturing-conditions data received by said manufacturing-conditions-data receiving means and by obtaining said correction data, and
a control-data transmission means that transmits to said control unit the control data created by said control-data creation means; and
said control unit includes
a control-data receiving/controlling means that receives control data from said control management unit and controls said mixer based on the control data.

4. The mixer control system according to claim 3, wherein
said correction data consists of the correction values of
the temperature of the raw materials at the time of mixing, and the mixing time for said mixer,
with said correction values corresponding to
the weights of the raw materials,
the temperatures of the raw materials, and
the temperature of the room, and
with said correction values being intended to correct the feed-water temperature, based on the manufacturing-conditions data received,
and said control-data creation means consists of
a feed-water-temperature calculation means, which calculates the feed-water temperature in order to obtain a desired finishing temperature of the product based on said correction values, and
a feed-conditions setting means, which sets the feed conditions, including at least the mixing time of said mixer and the feed-water temperature of the product, according to the feed amounts of the raw materials based on said correction data.

5. The mixer control system according to claim 3, wherein
said database consists of
control instruction information, which consists of the rotation speed and the rotation time of said mixer by the name of each particular product, the name of each raw material used, and each step of the manufacturing process,
correction information for
each feed amount, which consists of the corrected rotation time for each product by its name, the name of each raw material used, and the preset amount of each raw material used, and
each feed-water temperature, with said correction information consisting of the corrected rotation time for each predetermined feed-water temperature;
said control-data creation means
searches said database by using
the product names, the names of raw materials, and the feed amounts of the raw materials obtained by said manufacturing-instructions-data acquisition means, obtaining said control-instruction information and correction information for each feed amount,
the feed-water temperature of the manufacturing-conditions data received by said manufacturing-conditions-data receiving means, obtaining said correction information for each feed-water temperature, and
calculates the total corrected rotation time by adding
the corrected rotation time of the obtained correction information for each feed amount, and
the corrected rotation time of the obtained correction information for each feed-water temperature, and
creates control data, including the calculated rotation time obtained by multiplying the rotation time of said control-instruction information by the normalized value obtained by dividing the total corrected rotation time by the predetermined rotation time for each step of the manufacturing process.

6. The mixer control system according to claim 3, wherein
said manufacturing-conditions data includes data concerning changes in the temperature of the product during the manufacturing process,
said control instruction information includes the target finishing temperature for the particular product, and
said control-data creation means searches for the corrected rotation time corresponding to the value calculated by dividing the difference of the temperature by the preset temperature in said database if the temperature of the product in the manufacturing-conditions data during the manufacturing process fails to reach the target temperature when the making of the particular product has been completed, and creates the control data for further production by further adjusting the corrected rotation time according to the preset rotation speed for the manufacturing process.

7. The mixer control system according to claim 3, wherein
said manufacturing-conditions data further includes the humidity of the room's air;
said database further includes recipes information consisting of the standard usages of the raw materials, including the feed water, when supplying said mixer with the raw materials for a product, and
said control-data creation means further includes a log-information registration means, which creates log information by adding the manufacturing-conditions data, including the humidity of the room's air information, to said control data, and registers the log information into the database;
said control management unit
includes a means of registering the mean-humidity of the room's air, with said humidity-registering means obtaining, by searching said database, the log information that was registered on that day,
supplements the mean-humidity of the room's air by calculating said mean-humidity by using obtained log information, and registers said mean-humidity—together with the recipe information—in the database;
said control-data creation means
obtains the corresponding recipe information by searching said database by using the product name in the manufacturing instructions data obtained by said manufacturing-instructions-data acquisition means,
subtracts the manufacturing-conditions data regarding the humidity of the room's air from the mean humidity of the room's air of the recipe information obtained, so as to calculate the difference between those two values,
searches for the corresponding correction value using the value obtained by dividing the calculated difference in the humidity of the room's air by the desired humidity of the room's air at set forth in said database, and
creates control data by adding the corresponding correction value to the standard usage of the feed water of said recipe information.
